(19) United States
(12) Patent Application Publication
(10) Pub. No.: US 2002/0032663 A1
(43) Pub. Date: Mar. 14, 2002

(54) Apparatus and method for performing secure network transactions

(76) Inventor: Marc A. Messner, Edmond, OK (US)

Correspondence Address: Edward L. White, P.C., 50 Penn Place, 4th Floor, 1900 N.W. Expressway, Oklahoma City, OK, 73118-1803, US

(21) Appl. No.: 09/927,292

(22) Filed: Aug. 13, 2001

Related U.S. Application Data
(63) Continuation-in-part of application No. 09/340,603, filed on Jun. 28, 1999.

(51) Int. Cl. G06F 17/60; H04K 1/00; H04L 9/00

(52) U.S. Cl. 705/72; 705/26

(57) ABSTRACT

An personal electronic apparatus for providing security of specified electronic transactions, the personal electronic apparatus comprising an article removably inserted into the personal electronic apparatus, the article bearing a machine readable code; customer-specific code installed in the personal electronic apparatus, the code effecting the operation of the personal electronic apparatus; verifying means for determining whether the article is installed in the personal electronic apparatus, and, if so, for enabling specified electronic transactions, but, if not, for preventing said transactions; whereby, upon a specified request by the user, the personal electronic apparatus queries whether the article is installed, and, if so, enables specified transactions to be performed at the request of the user, but prevents the transaction from being performed if the article is not installed. A method of setting up the foregoing system is provided comprising the creation of a customer account at a bank pursuant to communication with the customer; creating customer-specific software with the bank, then splitting into a first portion and a second portion; mailing an article with the first portion thereon to the customer who then inserts the article into the personal electronic apparatus; a customer contacting the bank download server via the Internet and downloading the second portion to the personal electronic apparatus, then the bank download server erasing a copy of the second portion therefrom, but retaining relevant information on the bank purchase server; and the personal electronic apparatus linking the first and second software portions into working software on the personal electronic apparatus. A system of sub-accounts for each customer account is also disclosed allowing for separate accounting for various purchases and other financial transactions in different account set ups.

### CROSS REFERENCES TO RELATED APPLICATIONS

This application is a continuation-in-part application of U.S. patent application Ser. No. 09/340,603, for Apparatus and Method for Performing Secure Network Applications, filed Jun. 28, 1999.

### BACKGROUND OF THE INVENTION

a. Field of the Invention

The invention relates to devices and methods for securing electronic transactions. More particularly, the invention relates to devices and methods designed to protect confidential information and secure transmissions made via electronic networks.

b. Description of the Prior Art

The concept of electronic transactions is relatively new. Ignoring transactions pursuant to telephone calls involving a real person on each end, the concept of electronic transactions between two electronic devices was practically unknown until banks pioneered electronic transactions for wire transfers of large quantities of cash.

With the rise of the Internet in the early 1980s, long distance electronic transactions became possible for the general public. However, electronic commerce transactions were still relatively rare outside of the above-noted banking transactions until the early 1990s. This was partly because the technologies required for such transactions were not well developed. Also, until the early 1 990s there were still a relatively small number of consumers with access to the Internet.

The term “Internet” will be used throughout this document. As used herein, “Internet” means a network of machines accessible to/by multiple users, the machines having the capability, using a common communication protocol, of communicating pursuant to programming commands or information input by users. One specific embodiment of the term Internet is the computer network currently operating to allow users to communicate with remote servers using the Transmission Control Protocol/Internet Protocol (“TCPA/IP”). The terms “computer network,” “long distance network,” “electronic network” and other variations of these phrases may be used interchangeably in this document, and are intended to be coextensive with the term “Internet,” but should generally be understood to be limited to systems using TCP/IP.

Recently, there has been an exponential increase in the number of people with access to the Internet. Consequently, Internet business has proliferated. Great quantities of capital have poured into businesses related to the Internet. However, the full potential of the Internet for commercial transactions has not been realized. This is in large part due to concerns among consumers about the RBe: security of transactions over the Internet. A 1999 study by Ernst & Young addressed the reasons why consumers had not purchased goods, services or information on the Internet: 97% stated that they were uncomfortable sending credit card data across the Internet. “Internet Shopping Study: The Digital Channel Continues to Gather Steam,” page 11, Ernst & Young, LLP (1999) (study sponsored by the National Retail Federation).

Consumers' concerns are justified to some extent. There are at least two types of theft which can occur with Internet transactions: First, communications containing confidential information can be intercepted by parties other than the intended recipient; Second, what appears to be a legitimate business, may actually be a front for con men. Confidential information transmitted over the Internet can be intercepted by hackers. These hackers can then use that confidential information to commit fraud or theft (for example, making charges on credit card information intercepted on the Internet). Also, when a user/customer purchases goods or services over the Internet, there is little, if any, way for the customer to know that the merchant/supplier is legitimate. A web site which appears to be a legitimate business may, in fact, be a front established by con artists who plan to use the credit card and other information they obtain to defraud unsuspecting consumers.

In order to reduce security concerns, there are currently two primary competing technologies vying for dominance to provide “secure” Internet transactions: (1) Secure Sockets Layer (“SSL”) protocol and (2) Secure Electronic Transactions (“SET”). Both of these technologies assume that transactions on the Internet will use existing means of payment, most commonly credit card accounts (such as Visa®, Mastercard®, American Express®, and the like). SSL and SET are basically mathematical tools designed to encrypt the data related to these existing means of payment, to minimize the risk that this data may be intercepted and misused by an unintended recipient. Both SSL and SET also incorporate communication paths intended to ensure the integrity of transmissions. SET goes further than SSL in verifying the authenticity of entities using the system. Each user in SET is assigned unique identifiers and are given keys tied to their identifier. For purposes of this document, technology such as SSL and SET may be referred to as “encryption methods,” which is also intended to include other methods of encrypting data.

A Nov. 2, 1998, White Paper by the Gartner Group was titled “SET Comparative Performance Analysis” (“Wite Paper”). The White Paper compared the performance of SET to the performance of SSL on existing computing technology. The White Paper also speculated about what improvements in technology, anticipated to occur in the near future, will mean to the performance of both SET and SSL. The White Paper addressed criticism of SET, which alleged that its performance was slow which would result in either an unacceptable customer experience or an unjustified investment to ensure sufficient speed for the customer. The White Paper concluded that SET, which is more secure than SSL, is in fact slower. Hardware acceleration will be required for current technologies to use SET. The White Paper anticipated that as servers improve in performance such acceleration will not be necessary. However, for large e-commerce server applications, the support of SET requires an additional hardware acceleration in the medium term resulting in a five to six percent difference in server costs. Thus, though SET provides greater security, it also provides greater burdens.

SSL “Secure Sockets Layer” protocol is in common use today in many e-commerce servers. SSL offers “session-level” security. This means that once a secure session is established, all communication over the Internet is encrypted. Effectively, using SSL is the equivalent of using a scrambler on the telephone line over which a customer is placing a catalogue purchase using traditional telephones. Data sent from the customer arrives at the merchant's website, the information is decrypted then used by the merchant. How the information is stored and used by the merchant is completely out of the control of the user. Under SSL the customer: (1) has to trust the merchant will guard their credit card information securely, and the customer is assuming a risk in doing so; and (2) the customer has no assurance that the merchant is authorized to accept credit card payment.

By contrast SET insures that both the merchant and the customer are who they appear to be. That is, it insures that the merchant is actually a provider of goods and services who is authorized to receive and process credit card transactions. Similarly, SET insures that the customer is in fact the person who is authorized to use the credit card number being supplied. Whereas with SSL, all information sent on a secure connection is encrypted, with SET, only sensitive information (for example name, address, credit card number, etc.) is encrypted. Thus, the non-encrypted information sent using the SET protocol is faster than SSL. However, the overall performance of SET is slower than SSL.

The Nextcard® has attempted to address the issues of security and customer confidence in a different way. The Nextcard is called a “VISA card for Internet users.” The Nextcard attempts to safeguard a user/consumer's credit information by physically storing the information in an extremely secure environment. In addition, SSL is used for all transactions involving the Nextcard. The basic premise, however, of Nextcard is that “when you use your Nextcard VISA to make purchases over the Internet, you are never liable for fraud.” Nextcard guarantees customers that they will not incur losses due to fraud over the Internet. There are no restrictions regarding the sites from which a Nextcard customer can make purchases. Similarly, if the Nextcard® is stolen by a merchant, the customer is not liable. If the real card is stolen by someone who then attempts to use the card on the Internet, a customer is still protected. A customer using a Nextcard online, should have no worries about security or the like. He is substantially protected by the “safe shopping pledges^{SM}.”

However, all of the above systems suffer from the same flaw regarding the Internet: namely, they attempt to adapt a set up which was designed for purchases made at a merchant's facility to the needs of the Internet. The basic system used for VISA, Mastercard and other cards was not designed with commerce on the Internet in mind. Therefore, traditional VISA and Mastercard systems adapted to use online cannot take full advantage of the computer environment provided by the Internet.

U.S. Pat. No. 5,892,825 to Mages, et al., discloses a method of secure server control of local media via a trigger through a network for instant local messages of encrypted data on local media. In simple language, Mages allows a great quantity of information to be transferred to a user on a CD ROM. The information on the CD ROM is “crippled,” i.e., it cannot be accessed, unless the user makes an online connection to the provider of the data. Once the online connection is made, a key is transmitted, which is a very small file, allowing use of the data on the CD ROM. Mages avoids the problem of transferring a large volume of data across the Internet, which is slow and cumbersome and often problematic. The data is transferred simply and easily through the use of the CD ROM, and the provider of the data is insured that the data will not be used without appropriate authorization because of the crippling mechanism which can only be remedied through acquisition of a key online.

Two Japanese patents disclose related security systems: (1) JP-9,167,179 to Yamaha, discloses a software selling apparatus; (2) JP-11,345,208 to Aibikkusu KK, discloses an individual authentication system for the Internet. French patent number 2,751,104 (European patent number 818,763) assigned to France Telecom and others discloses a system which appears to be very similar to Aibikkusu; a U.S. application corresponding to the above-noted French patent issued as U.S. Pat. No. 6,205,553 B1 to Stoffel et al. Yamaha discloses a server in communication with sub-terminals, presumably (though not so specified) via the Internet. Each sub-terminal has memory and can write the software to be sold to a floppy disk and/or print information related to the purchase. Aibikkusu discloses an individual authentication system which authenticates an individual seeking access to a circuit by comparing information provided by the individual with data recorded on a CD-ROM. After authenticating the individual, a server judges the authenticity of the CD-ROM inserted in the client system.

Mages provides for transmission of a portion of data to a client via an alternative medium (in Mages a CD ROM, and in Yamaha a floppy disk), and transmission of a second portion of the data (a key to undo the crippling feature) to the user via the Internet. Once the key is obtained via the Internet, the software is authorized to operate within the parameters of the licences granted (i.e., for a specified time frame performing specified operations).

Both the Mages and Yamaha patents are directed towards preventing an end user from obtaining unauthorized access to either software or video/audio files. The concern with both Mages and Yamaha is that their customer will obtain a copy of the software or multimedia information and use it without paying for the information or without other appropriate authorization from the seller/licensor of the software or multimedia products. Thus, the protections in the Mages and Yamaha patents are directed at preventing the intended customer from gaining unauthorized access to the information. It would be advantageous to have a similar protocol which is designed not to prevent the intended customer from gaining unauthorized access to the information, but rather aimed at preventing third parties from gaining unauthorized access to the information. That is, where the information transmitted to the customer is to be part of a payment processing system, it is desirable to insure that the person actually using the payment processing system is the intended customer. The concern is not that the customer will utilize the payment system without paying the seller/licensor of the system. Rather, the concern is that a third party will obtain the user's account information and make unauthorized purchases therewith. For example, in the present invention, a pin number is required to link the first and second portions of the software to allow the system to operate. The pin number is transmitted to a user at the time the account is set up either online or via telephone so that when the article arrives in the mail, the pin number is not supplied therewith and the system cannot be activated unless the customer is the same one who received the pin number when the account was set up.

Aibikkusu and Stoffel (U.S. Pat. No. 6,205,553 B1) disclose a system conceptually very much like the present invention. Aibikkusu specifically envisions the use of a CD-ROM as a physical token, which incorporates authenticating information thereon; Stoffel specifies the use of a “smart card” as the physical token. Aibikkusu prescribes a two-step authentication procedure: first, the user is authenticated by the client system by comparing information provided by the user with information on the CD-ROM; second, if the first step is successful, a server in communication with the client system via the Internet automatically authenticates the CD-ROM. Stoffel discloses a multi-provider media (described as a smart card) which can be used to access services as diverse as obtaining cash from an ATM to parking garage access to subway access. Stoffel's system requires the user to first obtain the multi-provider media from a system administrator. The user then activates the media with, for example, his bank for ATM purchase, his parking garage for parking access, and with the city for subway access. When the media is presented in association with a request for services, the administrator through a series of private and public keys authenticates the media. Stoffel does not provide for a means of authenticating the user (e.g., a pin number). Unlike the present system, no customer-specific code is installed on the device which is reading the Stoffel media; rather, all of the customer-specific software required by Stoffel resides on the media. Aibikkusu does not require the user to send any authenticating information to the server; rather, a local authentication procedure takes place which, if successful, is followed by authentication of the CD-ROM by the server.

### SUMMARY OF THE INVENTION

In view of the foregoing disadvantages inherent in the known types of means for securing electronic transactions, it is an object of the invention to provide an apparatus and method which overcomes the various disadvantages of the prior art.

It is therefore an object of the invention to provide a means for facilitating online transactions, and for insuring the security of such transactions. It is an object of the present invention to provide a system to take the place of traditional Visa, Mastercard or other credit card systems for executing purchases online. The present system is intended to be used by consumers to facilitate online purchases of goods or services by secure means. It is anticipated that users of the present invention will access the Internet primarily via personal computers but also, to some extent, using personal digital assistants (“PDAs”), Internet appicances (such as “Web TV”), and other electronic devices capable of containing user-specific code and capable of accommodating an article.

It is a further object of the invention to provide a credit card-like system which is available for use exclusively on the Internet. It is also an object of the invention to provide features for the Internet-only credit card system which take full advantage of the computer environment. For example, it is an object of the present invention to provide a billing system used in conjunction with the Internet only credit card whereby billing statements, instead of being sent by regular mail, are sent by e-mail to the customer. This takes advantage of the fact that e-mail is free, incurring no mailing charges for the credit card issuer. In addition, billing transactions are more rapidly completed as are payment transactions. In fact, using the present invention, there could be transactions that are completely paperless. That is, transactions where no paper is sent from or to any of the parties involved in the transaction.

It is a further object of the present invention to incorporate features of electronic “wallets” which lessen the burden on a user executing an Internet transaction. In essence, using the present invention and a “wallet,” the only data required to be entered by a user to execute a transaction would be a pin number and the description of goods or services to be purchased. In addition, where a user has more than one account of the type employing the present invention, the wallet will allow a user to select the proper account he wishes to use for a transaction.

It is a further object of the present invention to provide a secure system for purchases online. The security of the system is insured by the requirement that a user desiring to execute purchases online must have a digital information storage device (referred to herein as an article or media) physically present in his computer system. If the article is not present, the transaction cannot be completed. This “article” takes the place of a traditional credit card in real world purchasing systems. That is, the “article” is a physical asset, under the control of the user, which, if not present, invalidates or disables the purchasing system. Thus, a thief, acquiring a card number from this system would not be able to execute purchases without having the physical asset present also. This substantially complicates a thief's job in attempting to use a credit card number without the owner's authorization. A “keycode” ensures that the article is present when a customer attempts to authorize a transaction; that is, the keycode authenticates the article. The is authenticated by, for example, requiring a pin number to authorize a requested transaction. Thus, there are two layers of authentication required to operate the present invention: authentication of the article using a keycode unknown to the user; and authentication of the user using a pin number not provided on the article. This double security measure decreases the odds of theft by third parties.

It is also an object of the present invention to provide an apparatus and method for using multiple key codes with a single account number. This would allow, for example, for a family to set up a separate account for a wife's checking, for a wife's purchases, for a husband's purchases, and for the dependents' purchases. If desired, the same pin number could be used for all of these accounts. However, if, for example, the husband and wife wish the dependents from accessing excessive credit, they could limit the dependents' account to a specified maximum, and use a separate pin number for the children's account different from their own. Where multiple key codes are provided under one account number, the information sent to a merchant would remain the same as where there were only one key code. However, a particular key code would be sent to the bank, allowing the bank to account for the purchases under the different sub-accounts.

It is finally an object of the present invention to provide an apparatus and system which can be used with existing encryption technology such as SET, SSL, as well as with credit card set ups like the Nextcard®. The present invention simply adds additional security to such systems. In the case of the Nextcard the present invention would lessen the potential liability of the provider of the Nextcard.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in this application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. Additional benefits and advantages of the present invention will become apparent in those skilled in the art to which the present invention relates from the subsequent description of the preferred embodiment and the appended claims, taken in conjunction with the accompanying drawings. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the invention of the application which is measured by the claims, nor is it intended to be limiting as to the scope of the invention in any way.

### BRIEF DESCRIPTION OF THE DRAWINGS

The invention will be better understood and the objects other than those set forth above will become apparent when consideration is given to the following detailed description thereof. Such A description makes reference to the annexed drawings wherein:

FIG. 1 is a schematic representation of the present invention.

FIG. 2 is a flow chart illustrating the set up procedure.

FIG. 3 is a flow chart illustrating the operation of the present invention.

FIG. 4 is a symbolic representation of one system which can be used to implement the present invention, and particularly the sending of the various data packets.

### DETAILED DESCRIPTION OF PREFERRED EMBODIMENTS

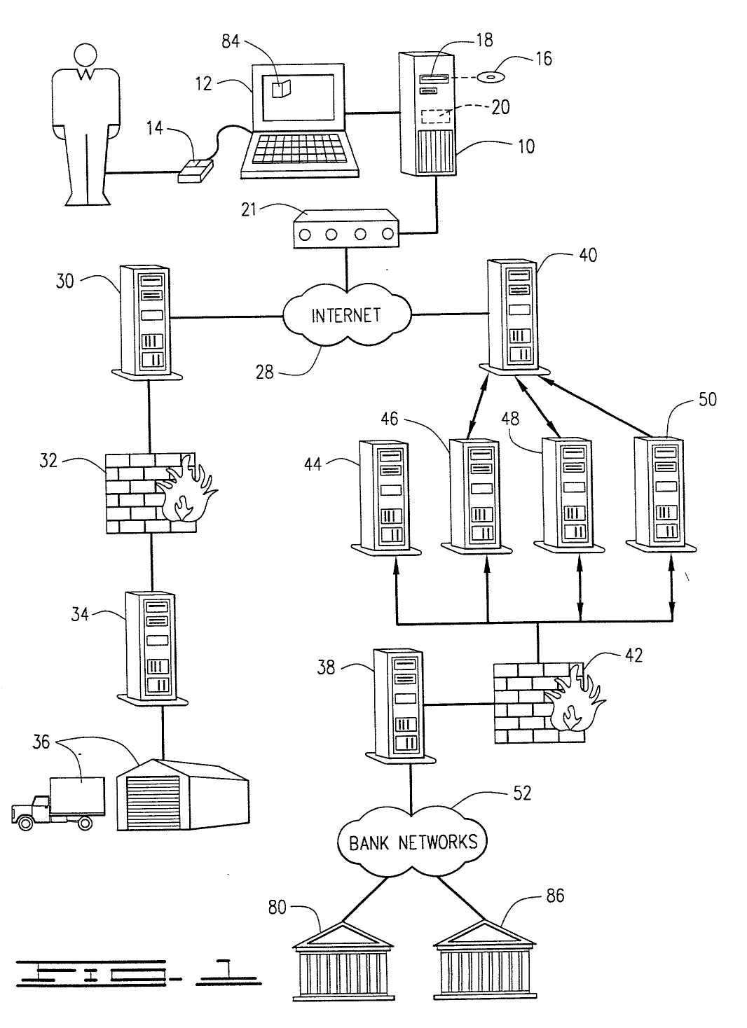

Referring now to the drawings, where like numerals represent like parts, the present invention as shown in FIG. 1 incorporates an personal electronic apparatus 10 such as a personal computer. It should also be understood that, rather than using the personal computer, a net device such as a “web TV” system could also be used, though improvements and additional features may need to be made to web TV systems presently available before they could accommodate the present invention. In the future, additional devices (such as personal digital assistants) will be developed specifically to access the Internet and to perform transactions thereon. All of these devices can be represented by the personal electronic apparatus 10. However, the personal electronic apparatus 10 does not include specific purpose devices publicly available in fixed locations such as Kiosks (at malls for example) or automated teller machines (“ATMs”). The personal electronic apparatus 10 could be, by way of distinction, a personal computer publicly available in a fixed location (for example an “internet cafe”) with access to the Internet and the capability to perform the same range of operations as a home personal computer. A primary distinction of the personal electronic apparatus from publicly available devices, not included within the scope of the present invention, is that the personal electronic apparatus is adapted to receive and retain in nonvolatile, long-term storage (such as a “hard drive”) customer-specific code or software for use in the present invention.

Cooperating with the personal electronic apparatus 10 is a display screen 12. The display screen 12 allows the personal electronic apparatus 10 to display various messages. Also cooperating with the personal electronic apparatus 10 are one or more data input devices 14. The data input devices 14 could be a keyboard, a mouse, a microphone for inputting the user's voice and/or voice commands, and the like. Additional input devices are possible, and they are intended to be incorporated within the spirit of this invention.

Also incorporated within the personal electronic apparatus 10 is an article reader 18. It is anticipated that the article/media 16 will be, at least initially, a read-only compact disc. The article/media 16 could also be any number of other devices, such as a web card envisioned by U.S. Pat. No. 5,247,575. The card in question has the look of a typical credit card, but also can be read by a regular CD reader. A floppy disk with security features could also be used.

The personal electronic apparatus 10 will also have incorporated thereon a customer-specific software/code 20. There will, by necessity, need to be either memory or hard drive-type devices to store the customer-specific software/code 20. The personal electronic apparatus 10, also will preferably incorporate an electronic wallet 84. Electronic wallets are relatively new software elements. The electronic wallet 84 precludes the need for the user to specifically input his personal data, such as mailing address, social security number, and the like, when purchasing goods or services over the Internet. The electronic wallet 84 may also incorporate features to track expenditures on the Internet. The wallet will also facilitate use of multiple sub-account numbers, using different key code numbers under the same account number. The personal electronic apparatus will also incorporate a communication means 21 for communication with a computer network 28. The communication means 21 may be a typical dial-up modem, a cable modem, a dedicated digital connection, a digital service line (“XDSL”), a satellite or other wireless connection, or the like.

Once a communication link is established via the communication means 21 with a computer network 28, a further link can be established with a supplier/merchant server or website 30. Goods and/or services may be offered for sale on the supplier/merchant server 30. The supplier/merchant server 30 may also be in communication with the merchant business server 34. This communication typically will occur through a firewall 32. Customers typically cannot contact the merchants business server 34 directly, because it is protected by the firewall 32. The merchants business server 34 further drives business processes 36. Business processes 36 include inventory control, shipping, and the like. The personal electronic apparatus 10 can also communicate via the computer network 28 with a bank Internet server 40. The bank Internet server 40 may also be in communication with multiple devices such as a download server 46, a purchase server 48, and a billing server 50, which are further in communication via a firewall 42 with the bank account information server 38. The bank account information server 38 is the bank's main computer where financial records and information on customers are kept. The bank account information server 38 may be in further communication through a bank network 52 with a merchant bank 80 or the customer's bank 86. The bank account information server 38 may also drive a media writer 44. The purpose of the media writer 44 is to create article/media to be sent to customers upon creation of a new account, modification of an existing account, or re-issue of an article for an existing account.

### OPERATION

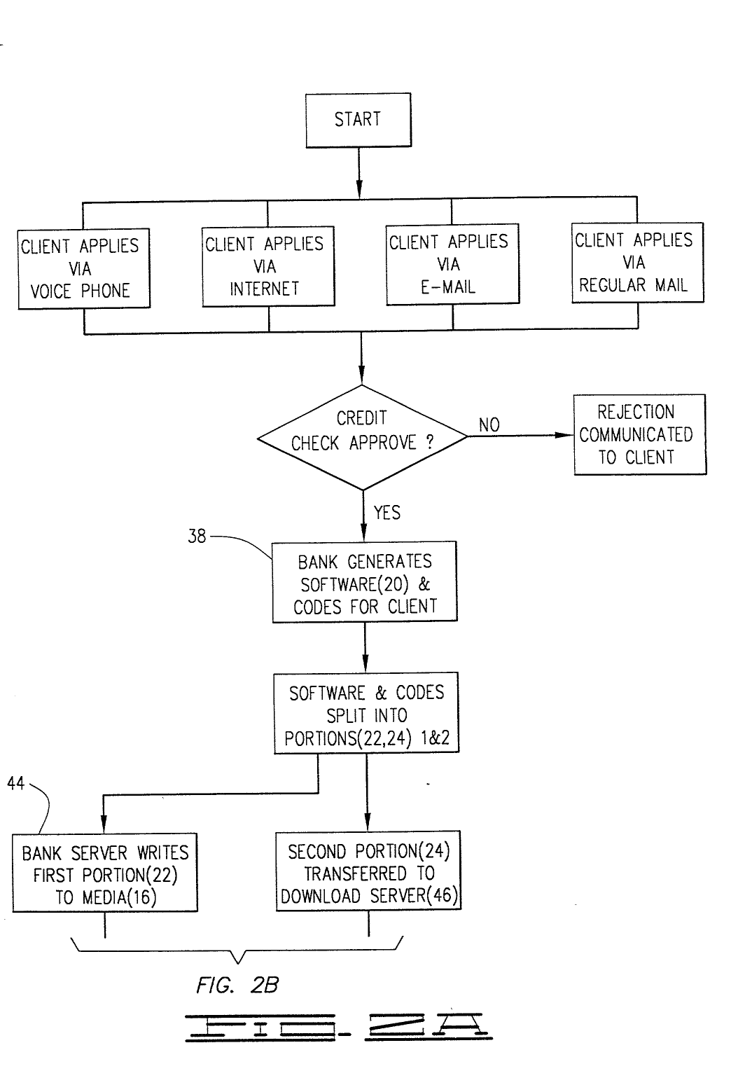

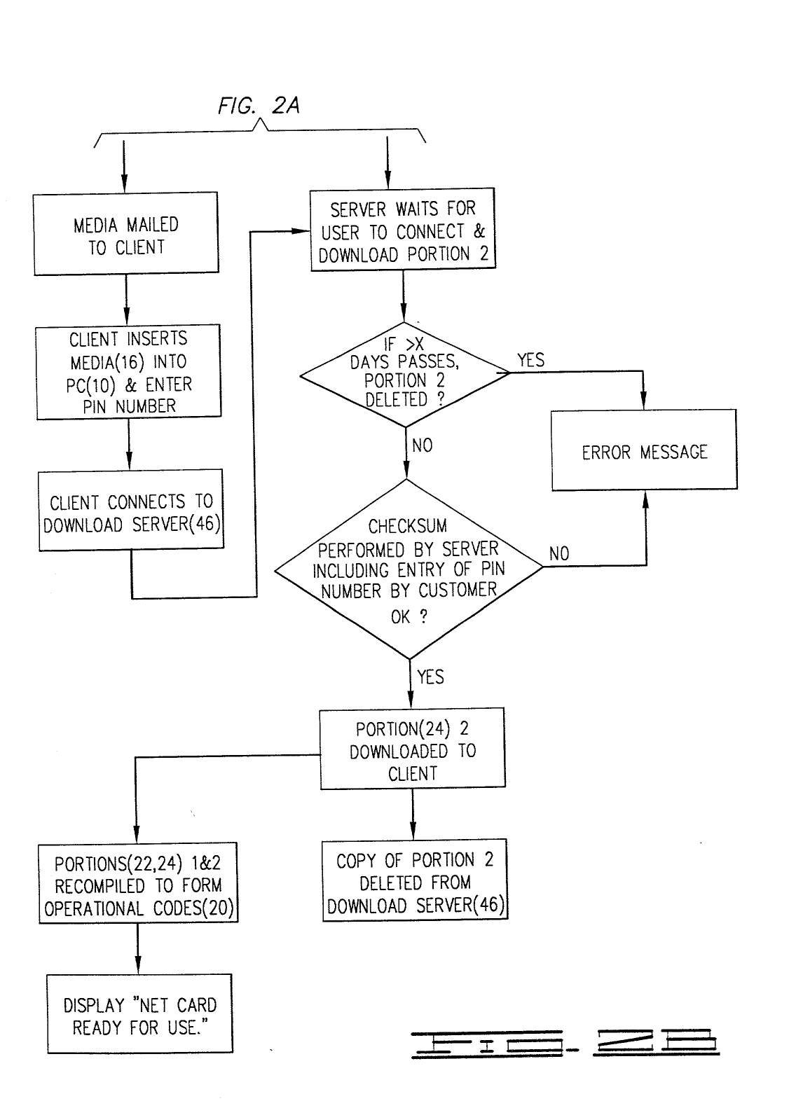

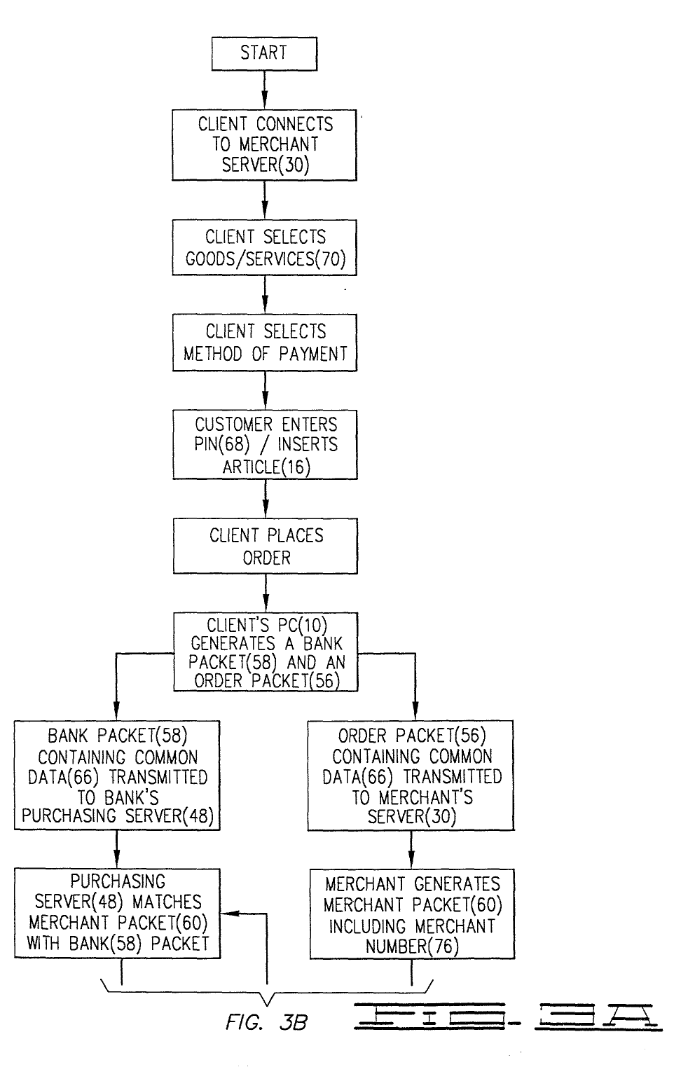

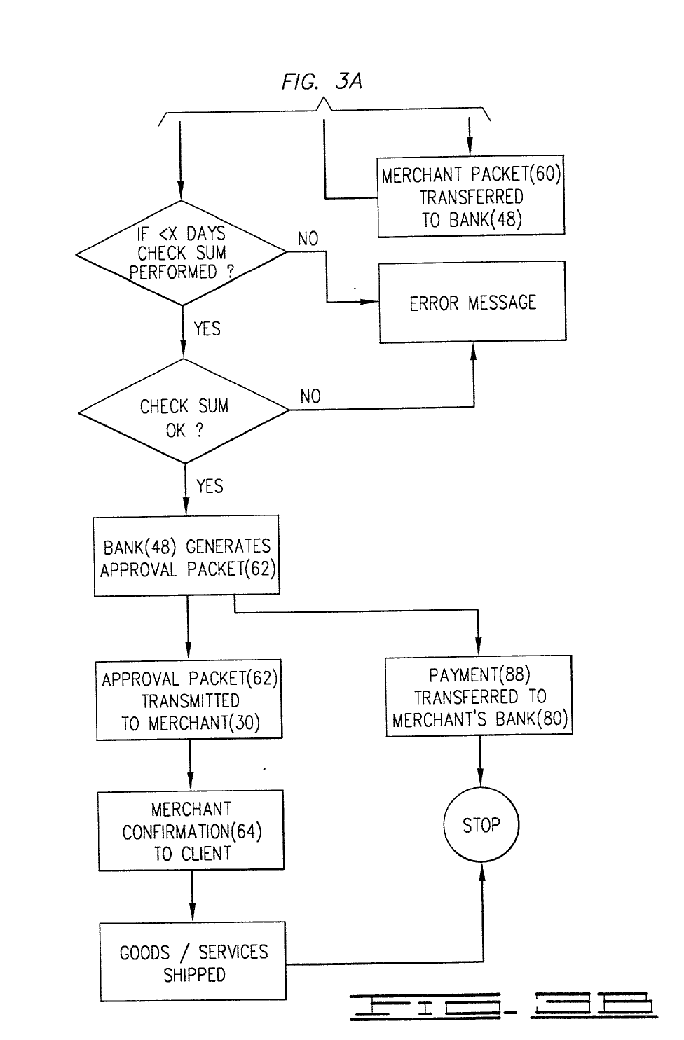

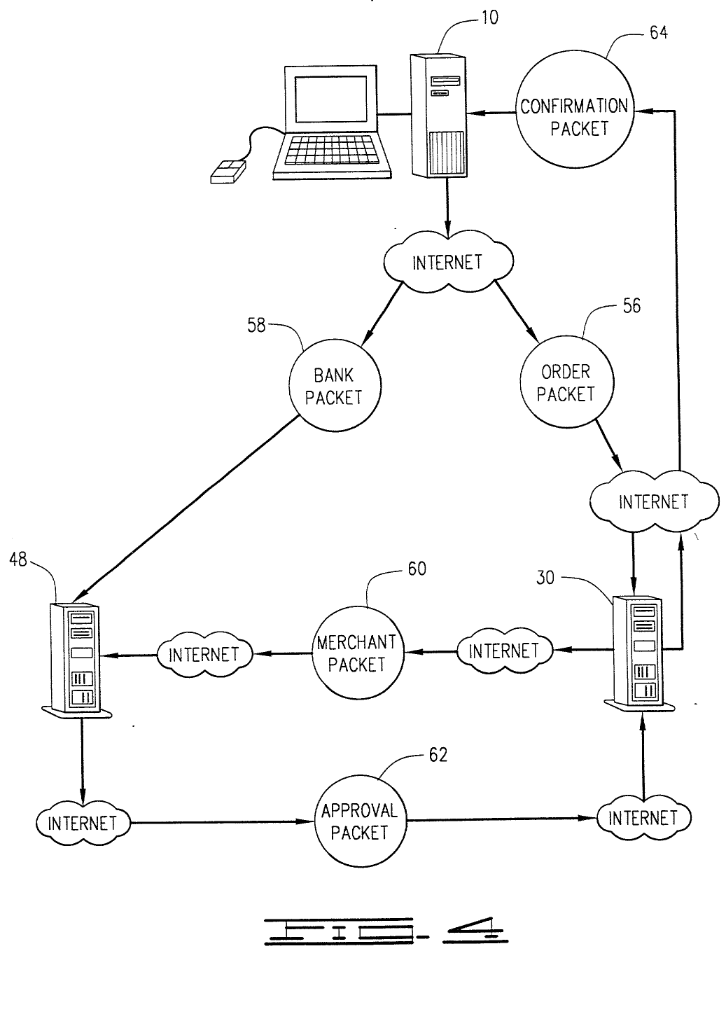

There are generally two phases to the operation of the present invention: first, a set up phase wherein the customer's or client's account is set up and codes are assigned, which is illustrated in FIG. 2; and second, an operation phase illustrated in FIGS. 3 and 4. FIG. 3 is a flow chart illustrating the operation of the present invention and FIG. 4 is a schematic representation of the flow of data among the bank, the customer, and the merchant.

FIG. 2 illustrates the set up phase. Set up starts when a customer contacts the bank or provider via a voice phone, Internet, e-mail, or regular mail. Additional means to set up an account may be available. It is not particularly relevant to the present invention whether the account is set up over the phone, via the Internet, or via some other alternative method. However, it is preferable that the account be set up over the Internet to minimize paper work, labor and other costs. Upon contacting the bank, the customer supplies information regarding, for example, his name, mailing address, billing address (if different from his mailing address), e-mail address, and various other personal data required for the bank's purposes. Also at the time of application, the customer may select or be assigned a pin number to be used with his account. This pin number is either selected by the customer or assigned by the bank and communicated to the customer at or near the time the account is established. The customer has been made aware of his pin number by the time he has completed the application process. Making the customer aware of the pin number at the time the application is processed provides additional security. Since the pin is not supplied with subsequent setup information and equipment provided to the customer, someone wrongly intercepting a setup packet through the mail would not be able to use it because the pin number would not be included with the mailed information. Since the pin number will not be provided with the information mailed to the customer, it is preferable that a reminder electronic communication (i.e., an e-mail) be sent to the customer at the time the account is established, the communication verifying acceptance of the customer's application and noting the customer's pin number.

A customer may also request multiple sub-accounts under the same account number. These sub-accounts may be, for example, for separate accounts for a husband and wife. Separate accounts could also be provided for dependent children. Each of these accounts could have separate provisions for credit limits. They could all use the same pin number, or they could have different pin numbers for each account or for groups of accounts. These separate sub-accounts would be particularly useful for institutional climates, such as cities or corporations. The entity could set up a master account, then give sub-account numbers to each department or division with separate credit limits and pin numbers. One billing statement would then be provided to the entity summarizing the purchases made under the sub-accounts. Each department or subdivision of the entity could be given a separate version of the article 16 for its account. A method is disclosed using multiple accounts. The method of multiple accounts is set up by a method of providing the personal electronic apparatus 10, creating a customer account at a bank pursuant to communication with the customer; creating customer-specific software 20 at the bank, then splitting the software 20 into a first portion 22, which is written to an article 16, and a second portion 24 which is transmitted to a bank download server 46; providing more than one key code number for each article, each corresponding to a sub-account depending from the same account number; mailing the article(s) 16 to the customer who then inserts it the article(s) into the personal electronic apparatus 10; the customer contacting the bank download server 46 via the Internet and downloading the second portion 24 to the personal electronic apparatus 10, then the bank download server 46 erasing the copy of the second portion 24 from the download server, but retaining relevant information on the bank purchase server 48; and the personal electronic apparatus 10 linking the first 22 and second 24 portions into working software 20; and the bank accounting separately for purchases under each key code number. As noted, one variation of this method is the creation of multiple articles 16 for the same account where multiple departments or sub-divisions are planning to use the same account. With multiple copies of the article 16 there is no need for a user to search for the common article each time a purchase is to be made.

Once the application is complete, the bank performs a credit check. If the customer is approved, the bank server 38 generates a unique version of the operating software 20 (which may also be referred to as “operational code”) and associated account numbers for the customer (i.e., an account number, pin number, and key code number). If the customer's application is rejected, such rejection is communicated to the customer.

Assuming the application is approved, the unique software 20 is may then be split into two portions, a first portion 22, and a second portion 24. The bank media server 44 writes the first portion 22 to the article/media 16. The article/media 16 is then mailed to the customer. Alternatively, the customer inserts the article/media 16 into his personal electronic apparatus 10. Some portion of the first portion 22 may then be written to a storage medium (such as a hard drive) on the personal electronic apparatus 10. This splitting of the operational software/code 20 (if elected) is a security feature; the system cannot be used with the first portion 22 alone. Further, the second portion 24 cannot be obtained without the pin number, which would be unknown to someone who improperly intercepted the article/media 16. The entire set of code could be sent on the article, but this would reduce te security of the system. Some level of security insurance would still be provided, however, by providing the pin number at the time of account setup and not providing it subsequently with the article.

At or near the same time as the first portion 22 is written to the article/media 16, the second portion 24 is transferred from the bank server 38 to a download server 46. The second portion 24 remains on the download server 46 for a specified time period. If the customer does not connect to the download server 46 within a specified time, the second portion 24 is erased from the download server 46. However, if the customer connects to the download server 46 within the specified time, the download server 46 performs a checksum. The user must enter his pin number 68, which is required to allow him to download the second portion 24, the necessary code is then written to a storage device (e.g., either a hard drive or RAM). If the checksum is not acceptable, an error message is displayed, and the customer is instructed to either contact the bank or a service provider to further explore what has happened to prevent him from successfully downloading the second portion 24. The customer must have inserted the article/media 16 into his personal electronic apparatus 10 and, pursuant to the programming, some portion of the software/code may have been written to the storage medium to satisfy the checksum. Further, the customer will be prompted to enter his pin number. If the checksum is successful, the second portion 24 is downloaded to the customer's personal electronic apparatus 10.

The first portion 22 and the second portion 24 are then linked in the users's personal electronic apparatus 10 to form operational software/code 20. Linking is not equivalent to re-compiling the first and second portion 22 and 24. Rather, linking amounts to recording appropriate information regarding the personal electronic apparatus 10 (such as IRQ addresses), the intercommunication of the two portions, and other pertinent information into appropriate code lines on the portion stored on the personal electronic apparatus 10. Thus, neither piece of the puzzle, the article/media 16 nor the portion of the operational code 20 stored on the personal electronic apparatus 10 alone is sufficient to operate the system. Both must be present for the system to function. The operational code/software 20 is formed by the two linked portions both being present in the personal electronic apparatus 10 at the same time. The pin number must be entered before the linking will be accomplished.

Once linking has been successfully completed a display 12 displays a message indicating that the present invention is ready for operation. At or near the same time, the second portion 24 is deleted from the download server 46. Thus, the software has been successfully set up on the user's personal electronic apparatus 10. The bank purchase server 48 maintains a copy of the needed information regarding the user. After the second portion is deleted from the download server 46, the software cannot be installed on another machine without re-contacting the bank to have the second portion again sent to the download server 46.

As with account setup for customers, accounts for merchants can be created via communication on the telephone, regular mail, e-mail or by other communication means. Once a merchant account is established, the merchant downloads a serialized copy of the merchant transaction software from the download server 46. The merchant transaction software incorporates a detection routine, which determines the nature of the merchant's application programming interface (“API”), then installs appropriate code within the merchant's web server application. The merchant's web server application does not need to be re-programmed from scratch. Rather, a “patch” is installed to add a branded payment button for the present invention, which, when selected by the customer, triggers the operation of the present invention.

FIG. 3 illustrates the operation of the system, once the system has been set up. The user first connects to a merchant server 30. This connection is established to or through a computer network 28 such as the Internet. The user or customer then selects the goods or services to be purchased. The customer then selects the present invention as the method of payment. At that time, the operational code/software 20 performs a checksum to ensure the article 16 is in place. If the article 16 is not in place, the customer is prompted to install it. No transactions will be allowed using the present invention until the article 16 is installed. Once the article is installed, the customer is prompted to enter his pin number. The software then transmits the order, a first part of which—the order packet 56—is sent to the merchant with a second part—the bank packet 58—sent to the bank 48. Upon receipt of the bank packet 58, the bank purchase server 48 begins scanning incoming data for a merchant packet 60 corresponding to the bank packet 58. Common data 66 contained in both the merchant packet 60 and the bank packet 58 enables the two to be matched by the bank purchase server 48. If the two packets arrive at the bank purchase server 48 within a specified time frame, a checksum is performed to verify that the account number 74, the pin number 68, as well as the keycode 72 match, and finally that the merchant number 76 is valid. If, however, too much time has elapsed between the time the bank packet 58 arrives at the bank purchase server 48 and the time the merchant packet 60 arrives, a message is displayed that too much time has elapsed, please place the order again, or similar message. When the checksum is performed, if it is successful, the bank purchase server 48 generates an approval packet 62. If the checksum is unsuccessful, a message is relayed to the personal electronic apparatus 10 of the user and the merchant, indicating that there was a problem with your order; please try again or call the bank, or similar message. Upon approval, an approval packet 62 is then transmitted to the merchant 30. The merchant generates a confirmation packet 64, which is transmitted to the user's personal electronic apparatus 10. At the same time, the merchant server 30 sends a command to the merchant business server 34 to deliver the goods or services. The business processes 36 within the merchant's organization complete this operation. In a preferred embodiment, simultaneously with the transmission of the approval packet 62 to the merchant, a payment 88 is transferred to the merchant bank 80 via bank networking 52.

FIG. 4 illustrates one system of transmitting data among the bank purchase server 48, the customer's personal electronic apparatus 10, and the merchant web server 30. The data packets corresponding to the system shown in FIG. 4 are shown below:

| Order Packet-1A (56) | | Bank Packet-1B (58) | |
|---|---|---|---|
| 1. Purchase No. | (66a) | 1. Purchase No. | (66b) |
| 2. Dollar Amount | | 2. Dollar Amount | |
| 3. Name | | 3. Keycode (72) | |
| 4. Address (shipping) | | 4. Pin No. (68) | |

| 5. Description of goods/ | Approval Packet-3 (62) | |
|---|---|---|
| services (70) | 1. Purchase No. | (66d) |
| 6. Account No. (74) | 2. Dollar Amount | |

| | |
|---|---|
| Merchant Packet-2 (60) | 3. Authorization No. (78) |

| | |
|---|---|
| 1.Purchase No. | (66c) |
| 2.Dollar Amount | |
| 3.Account No. (74) | |
| 4.Merchant No. (76) | |

The process is initiated by an order packet 56 and a bank packet 58 being sent by the customer's personal electronic apparatus 10. The order packet 56 comprises, at least:

common data 66 (e.g., a purchase number and a dollar amount); and

the customer's name and address, which are automatically sent to the merchant pursuant to information provided the bank at the time the account is set up;

the customer's account number; and

a description of the goods and services to be purchased 70.

The customer may indicate that he wishes to have the goods or services shipped to an alternative address, in which case he will check a box on the order form. The alternative address will then be provided by the customer, and this will be the address to which the goods are shipped, rather than the address provided to the bank at the time the account was set up. The purchase number is generated by the software 20 installed on the personal electronic apparatus 10. A log, preferably sorted by purchase order number, is maintained both on the personal electronic apparatus 10 and at the bank purchase server 48 detailing charges made by the customer.

Both the bank packet 58 and the order packet 56 contain common data 66. The common data 66 may be the purchase number and the dollar amount. Also sent in the bank packet 58 may be a keycode 72 indicating whether or not the article 16 is present in the article reader 18. Finally, included in the bank packet 58, may be the pin number 68.

Upon receipt of the order packet 56 the merchant 30 generates a merchant packet 60. The merchant packet 60 includes the common information 66 (namely the purchase number and dollar amount) as well as the account number 74 and a merchant number 76. The merchant number 76 is provided to the merchant upon establishing a merchant account with the bank. The merchant packet 60 is then sent to the bank purchase server 48 via the computer network 28.

Upon receipt of the merchant packet 60, the bank purchase server 48 attempts to match the merchant packet 60 with the bank packet 58. This matching occurs via the common information 66. If a match is made, the bank attempts to determine whether sufficient credit remains to authorize the purchase. If sufficient credit remains, an authorization number 78 is generated. This type of authorization approval is commonly performed with existing systems for purchasing goods and services over the Internet. The nature of the bank's internal approval process is not a critical part of the present invention. The common information 66 and the authorization number 78 are prepared

1. An personal electronic apparatus for providing security of specified electronic transactions, the personal electronic apparatus comprising:
a. an article removably inserted into the personal electronic apparatus, the article bearing machine readable code;
b. customer-specific code installed on the personal electronic apparatus, the code affecting operation of the personal electronic apparatus;
c. verifying means for determining whether the article is installed in the personal electronic apparatus, and, if so, for enabling specified electronic transactions, but, if not, for preventing said transactions;
whereby, upon a request for specified electronic transactions by the user, the personal electronic apparatus queries whether the article is installed, and, if so, enables specified transactions to be performed at the request of the user, but prevents the transaction from being performed if the article is not installed.

2. A purchasing method of purchasing goods and services via the Internet comprising the steps of:
a. a customer accessing a merchant's server and selecting desired goods and services and placing an order for same, the order resulting in the transmission of an order packet to the merchant and a bank packet to a bank's purchase server,
b. upon receipt of the order packet, the merchant generating a merchant packet and transmitting same so that it is received by the bank's purchase server;
c. the bank's purchase server matching the merchant packet with the bank packet using the common information as a key;
d. the bank's purchase service checking for accuracy of both the merchant and bank packet and determining whether sufficient credit remains on customer's account to authorize the transaction;
e. approving the transaction if step d is satisfactory, and transmitting an approval packet so that is received by the merchant;

3. A setup method for setting up a system to implement the method of purchasing goods and services via the Internet, the setup method comprising the steps of:
a. providing the personal electronic apparatus of claim 1;
b. creating a customer account at a bank pursuant to communication with the customer and relaying to the customer a pin number that will be required in a later step;
c. creating customer-specific software at the bank, then splitting the software into a first portion, which is written to the article and a second portion which is transmitted to a bank download server;
d. mailing the article to the customer, who then inserts it into the personal electronic apparatus;
e. the customer contacting the bank download server via the Internet and downloading the second portion to the personal electronic apparatus, then the bank download server erasing the copy of the second portion from the download server, but retaining relevant information on a bank purchase server; and
f. upon provision of the pin number by the customer, the personal electronic apparatus linking the first and second portions into working software on the personal electronic apparatus.

4. A billing method for billing customers for purchases made using the purchasing method of claim 2, the billing method comprising the steps of:
a. upon completion of a transaction or a set of transactions, the bank sending an electronic communication via the Internet to the customer listing the purchase made and the total amount due;
b. the customer selecting a method of payment and responding with same in an electronic communication via the Internet back to the bank; and
c. the bank completing the payment pursuant to instructions from the customer in the response electronic communication.

5. The method of claim 3, additionally comprising the steps of:
a. in step b of claim 3, providing more than one key code number, each key code corresponding to a sub-account depending from the same main account;
b. providing additional steps in the code which require a customer to select the key code that is to be used for a specific purchase, then providing for that key code to be sent to the bank purchase server along with the bank packet; and
c. accounting separately for the purchases made by a customer under each separate key code number.
